(19) United States
(12) Patent Application Publication
(10) Pub. No.: US 2005/0140814 A1
(43) Pub. Date: Jun. 30, 2005

(54) Connecting structure for connecting an image pick-up unit to a wiring plate

(75) Inventor: Satoshi Katakai, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 11/006,030

(22) Filed: Dec. 6, 2004

(30) Foreign Application Priority Data
Dec. 24, 2003 (JP) 2003-426692

(51) Int. Cl. H04N 5/225

(52) U.S. Cl. 348/340

(57) ABSTRACT

A pair of extending portions 13, 13 of a film plate 3 are firmly attached on side walls 2a, 2a of an image pick-up unit 2, which are formed in parallel with or on both sides of the optical axis 10 of an image pick-up element 7 held within the image pick-up element unit 2, and the plate connecting pads 14 provided on the pair of extending portions 13, 13 of the film plate 3 are stacked on top of the element connecting pads 11 provided on the side walls 2a, 2a of the image pick-up element unit 2. The film plate 3 is not staked on top of the image pick-up element unit 2 in the direction of the optical axis 10 of the image pick-up element 7. Therefore, an image pick-up unit containing the image pick-up element unit and a lens unit can be reduced in its dimension by an amount equivalent to a thickness of the film plate 3 in the optical direction of the image pick-up element.

### BACKGROUND OF THE INVENTION

The present invention relates to a connecting structure for connecting a wiring plate with an image pick-up element unit, which is used in an image pick-up apparatus such as an electronic camera and a video camera.

In a conventional electronic camera, a wiring plate is used to electrically connect a circuit board with an image pick-up element unit, which includes an image pick-up element such as a CCD chip. More specifically, the image pick-up element unit is provided with element connecting electrodes connected to the image pick-up element on an edge portion of its under surface, that is, on an edge portion of a lower surface of the image pick-up element which intersects with the optical axis of the image pick-up element at right angles. A wiring plate consisting of a film is disposed under the image pick-up element unit and the plate connecting electrodes provided on the wiring plate are stacked on top of the element connecting electrodes of the image pick-up element unit to electrically connect the image pick-up element unit with the wiring plate.

[Patent Document] Japanese laid-open patent application No. Hei7-78952

In the conventional connecting structure for connecting the image pick-up element unit with the wiring plate, the wiring plate is provided under the image pick-up electrode unit including the image pick-up electrode, and the element connecting electrodes provided on the under surface of the image pick-up element unit are stacked on top of the plate connecting electrodes provided on the wiring plate to be electrically connected with the same. Therefore, the dimension of the image pick-up unit increases in the direction of the optical axis of the image pick-up element by an amount equivalent to a total thickness of the plate connecting pad and the element connecting pad staked on top of the former, resulting in increase of the whole dimension of the electronic camera in the direction of the optical axis of the image pick-up element.

### SUMMARY OF THE INVENTION

According to one aspect of the invention, there is provided a connecting structure comprising: an image pick-up element unit including an image pick-up element; a wiring plate prepared to be attached to a side wall of the image pick-up element unit formed substantially in parallel with or on both sides of an optical axis of the image pick-up element; at least one element connecting pad provided on the side wall of the image pick-up element unit and electrically connected to the image pick-up element; and at least one plate connecting pad provided on the wiring plate, wherein the plate connecting pad is stacked on top of the element connecting pad provided on the side wall of the image pick-up element unit to be electrically connected with the same when the wiring plate is firmly attached onto the side wall of the image pick-up element unit.

According to another aspect of the invention, there is provided a connecting structure comprising: a lens unit containing a lens for picking up an image of an object; an image pick-up element unit containing an image pick-up element, and provided with element connecting pads on it side wall, the image pick-up element unit being fixed onto the lens unit such that an optical axis of the image pick-up element coincides with an optical axis of the lens; a wiring plate provided with plate connecting pads adapted to be electrically connected with the element connecting pads of the image pick-up element unit, wherein when the wiring plate is firmly attached onto the side wall of the image pick-up element unit, the plate connecting pads of the wiring plate are firmly stacked on top of the element connecting pads of the image pick-up element unit.

### BRIEF DESCRIPTION OF THE DRAWINGS

FIG. 1 is a perspective view showing an image pick-up unit of an electronic camera according to a first embodiment of the present invention.

FIG. 2 is an enlarged cross-sectional view of the image puck-up unit taken along the line A-A of FIG. 1.

FIG. 3 is an enlarged side view of the image pick-up unit.

FIG. 4 is an exploded view of a film plate shown in FIG. 1.

FIG. 5 is a perspective view showing an image pick-up unit of an electronic camera according to a second embodiment of the present invention.

FIG. 6 is a perspective view of the image pick-up unit according to a first modified embodiment.

FIG. 7 is an exploded view of a film plate shown in FIG. 6.

FIG. 8 is a perspective view of the image pick-up unit according to a second modified embodiment.

FIG. 9 is an exploded view of a film plate shown in FIG. 8.

### DESCRIPTION OF THE PREFERRED EMBODIMENTS

### First Embodiment

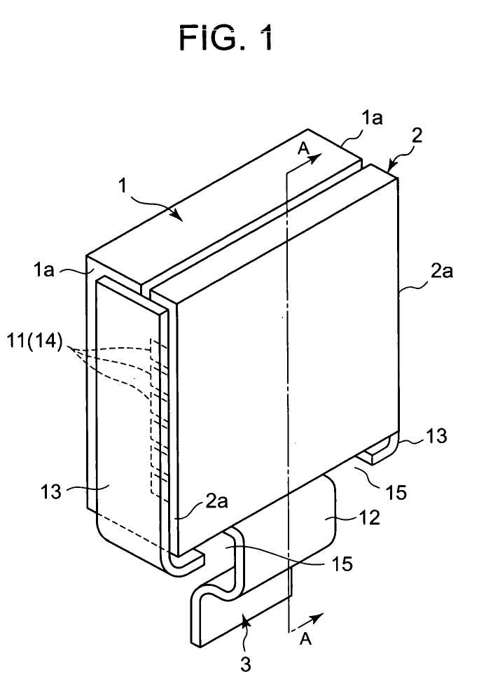

Now, a first embodiment of an image pick-up unit of an electronic camera according to the present invention will be described with reference to FIG. 1 through FIG. 4.

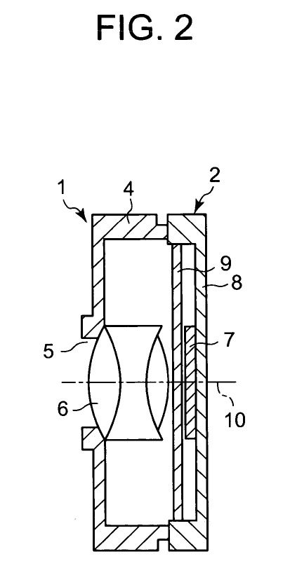

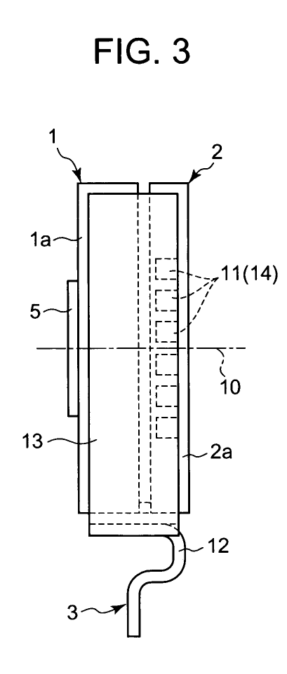

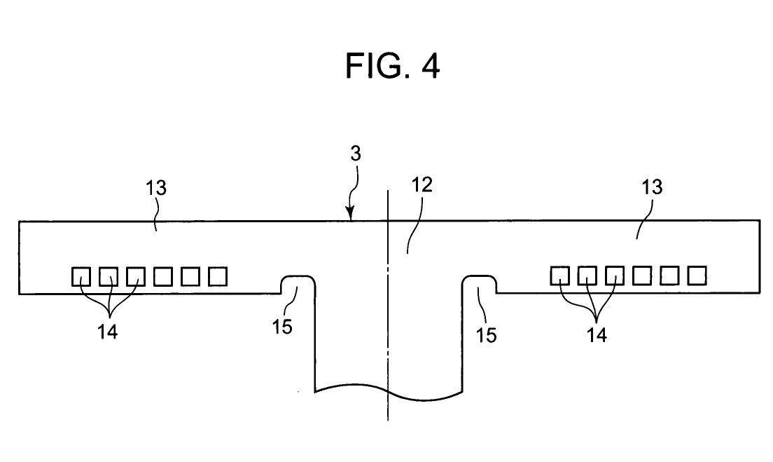

FIG. 1 is a perspective view showing the image pick-up unit of the electronic camera according to the present invention. FIG. 2 is an enlarged cross-sectional view of the image puck-up unit taken along the line A-A of FIG. 1. FIG. 3 is an enlarged side view of the image pick-up unit. FIG. 4 is an exploded view of a film plate 3 shown in FIG. 1.

As shown in FIG. 1 to FIG. 3, the image pick-up unit comprises a lens unit 1, an image pick-up element unit 2 disposed on a rear side of the lens unit 1 (at a right side of the lens unit 1 as viewed in FIG. 2), and the film plate 3 electrically connected to the image pick-up element unit 2.

The lens unit 1 has a unit case 4 as shown in FIGS. 1 and 2. The unit case 4 is formed with an opening 5 in its front surface (left side as viewed in FIG. 2) and is open to the rear side (right side as viewed in FIG. 2). In the unit case 4, an object lens 6 for picking up an image of an object is mounted so as to be exposed through the opening 5.

The image pick-up element unit 2 has an image pick-up element 7 such as CCD, which is contained in a package member 8, and an optical low pass filter 9 disposed in front of the image pick-up element 7, as shown in FIG. 2. The image pick-up element unit 2 is fixedly attached on the rear side of the unit case 4 (right side as viewed in FIG. 2) with an adhesive or screws. The image pick-up element 7 is disposed in the image pick-up element unit 2 with its optical axis 10 coincident with that of the lens unit 6, whereby an image of an object picked up through the lens unit 6 is thrown onto the image pick-up element 7 to generate image data of the object. On both side walls 2a, 2a of the image pick-up element unit 2, that is, on the side walls of the image pick-up element unit 2 located substantially in parallel with or on both sides of the optical axis 10 of the image pick-up element 7, there are disposed plural element connecting pads 11 electrically connected to the image pick-up element 7, as indicated by the broken line in FIG. 1 and FIG. 3. The film plate 3 is provided for electrically connecting the image pick-up element unit 2 with a circuit board (not shown). The film plate 3 has a central portion 12 to be connected to the image pick-up element unit 2 and a pair of portions 13, 13 extending from the central portion 12 to form a generally T-shape as viewed in FIG. 4. The pair of extending portions 13, 13 of the film plate 3 are bent so as to be tightly attached to the side walls 2a, 2a of the image pick-up element unit 2, as indicated in FIG. 1. The extending portions 13, 13 of the film plate 3 each are provided with plural plate connecting pads 14 adapted to oppose the element connecting pads 11 on the side walls 2a, 2a of the image pick-up element unit 2 respectively, as shown in FIG. 4.

The extending portions 13, 13 of the film plate 3 each have a dimension substantially equivalent to or slightly smaller than a dimension of an area including the side walls 1a and 2a of the lens unit 1 and the image pick-up element unit 2. Therefore, when the pair of extending portions 13, 13 of the film plate 3 are attached to the side walls 1a, 2a of the lens unit 1 and the image pick-up element unit 2, the extending portions 13, 13 do not protrude on either side of the area including the side walls 1a, 2a of the lens unit 1 and the image pick-up element unit 2. As clearly shown in FIG. 4, the film plate 3 is formed with cutouts 15, 15 at positions where the extending portions 13, 13 meet with the central portion 12, which cutouts serve to prevent the extending portions from billowing or bulging when they are bent to be attached to the lens unit 1 and the image pick-up element unit 2.

In the image pick-up unit, the image pick-up element unit 2 is attached to the rear surface of the lens unit 1, and when the image pick-up element unit 2 is connected to the film plate 3, the pair of extending portions 13, 13 of the film plate 3 are bent from the central portion 12 so as to form a generally Y-shape as viewed in the cross section, and the bent extending portions 13, 13 are closely attached to the side walls 2a, 2a and 1a, 1a of the image pick-up element unit 2 and the lens unit 1, as shown in FIG. 1, whereby the plate connecting pads 14 provided on the pair of extending portions 13, 13 of the film plate 3 are stacked respectively on top of the element connecting pads 11 provided on the side walls 2a, 2a of the image pick-up element unit 2.

It is useful for electrically connecting the element connecting pads 11 and plate connecting pads 14 to each other to previously apply solder (not shown) on either of the element connecting pads 11 and plate connecting pads 14. That is, the plate connecting pads 14 are stacked on top of the element connecting pads 11 provided on the side walls 2a, 2a of the image pick-up element unit 2 as described above, and are pressed to each other while heated by a pulse heater, whereby the pads 14 and the pads 11 are connected together by solder.

In the image pick-up unit, the pair of extending portions 13, 13 of the film plate 3 are disposed closely on the side walls 2a, 2a of the image pick-up unit 2, which are formed substantially in parallel with or on both sides of the optical axis 10 of the image pick-up element 7 contained within the image pick-up element unit 2, and the plate connecting pads 14 provided on the pair of extending portions 13, 13 of the film plate 3 are firmly stacked on top of the element connecting pads 11 of the side walls 2a, 2a of the image pick-up element unit 2. Therefore, the image pick-up element unit 2 and the film plate 3 are not stacked on top of another in the direction of the optical axis 10 of the image pick-up element 7.

The thickness of the image pick-up unit is made equivalent to a total thickness of the lens unit 1 and the image pick-up element unit 2 in the direction of the optical axis 10 of the image pick-up element 7, and can be reduced in its thickness by an amount equivalent to a thickness of the film plate 3 in the direction of the optical axis 10 of the image pick-up element 7. It is extremely effective for realizing an apparatus such as an extremely thin or compact camera to reduce a thickness of an apparatus even by this slight dimension such as the thickness of the film plate 3. With the connecting structure in the image pick-up unit, the pair of extending portions 13, 13 of the film plate 3 are attached firmly to both side walls 2a, 2a of the image pick-up element unit 2 to stack the plate connecting pads 14 on top of the element connecting pads 11, and the pads 11, 14 are pressed to each other while heated by the pulse heater, whereby the pads 11 and 14 are soldered. Therefore, the above mentioned connecting process may be automated.

In case where a flexible film plate 3 is used as a circuit board, even though the film plate 3 is firmly attached to the side walls 2a, 2a of the image pick-up element unit 3, the film plate 3 can be guided from the side walls 2a, 2a of the image pick-up element unit 2 by bending the same in any direction. Therefore, a location where the image pick-up element unit 2 is installed is not restricted by the circuit board (not shown) connected to the image pick-up element unit 2 through the film plate 2, and the image pick-up element unit 2 may be installed at any location without any restriction by the circuit board, and further usage of a thin film plate 3 allows to make the whole structure of image pick-up unit and electronic camera compact in size.

In particular, the film plate 3 consists of the central portion 12 having the pair of extending portions 13, 13, and the pair of extending portions 13, 13, are provided with the plate connecting pads 14, which are adapted to be stacked respectively on top of the element connecting pads 11 on both side walls 2a, 2a of the image pick-up element unit 2. When the extending portions 13, 13 are bent from the central portion 12 of the film plate 3 to be firmly attached on both side walls 2a, 2a of the image pick-up element unit 2, the plate connecting pads 14 may be connected to the element pads 11 without fail, even through the element connecting pads 11 are provided on both side walls 2a, 2a of the image pick-up element unit 2. As described above, using only one film plate 3, the element connecting pads 11 of the image pick-up element unit 2 may be easily and compactly connected with plate connecting pads 11 of the film plate 3.

The film plate 3 is formed with cutouts at its positions where the central portion 12 meets with the pair of extending portions 13, and therefore when the extending portions 13, 13 are bent to be attached on the side walls 2a, 2a of the image pick-up element unit 2, the cutouts serve to prevent the extending portions 13, 13 from bulging, allowing an easy bending operation, and the whole structure of the unit may be made compact.

### Second Embodiment

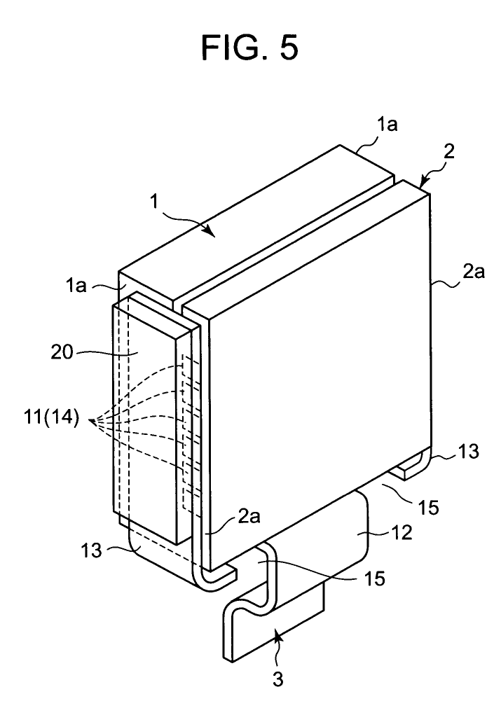

A second embodiment of the image pick-up unit of an electronic camera according to the present invention will be described with reference to FIG. 5. In FIG. 5, like portions as those in the first embodiment shown in FIG. 1 through FIG. 4 are designated by like reference numerals.

As shown in FIG. 5, a connecting structure of second embodiment of the image pick-up unit has substantially the same structure as the first embodiment except that reinforcing plates 20, 20 (one of them is not shown) are firmly attached to the external surfaces of the pair of extending portions 13, 13 of the film plate 3 attached to the side walls 2a, 2a of the image pick-up element unit 2.

With the connecting structure of the image pick-up unit, the image pick-up unit may be reduced in its dimension by an amount equivalent to the thickness of the film plate 3 in the direction of the optical axis 10 of the image pick-up element 2. Particularly, when attached to the side walls of the image pick-up element unit 2, the extending portions 13, 13 are prevented by the reinforcing plates 20 attached thereto from bending away from the side walls 2a, 2a of the image pick-up element unit 2, even through the film plate 3 is thin in thickness and flexible, whereby the pair of extending portions 13, 13 of the film plate 3 are firmly attached to the side walls 2a, 2a of the image pick-up element unit 2 and the plate connecting pads 14 are stacked precisely on the element connecting pads 11 to be firmly connected thereto.

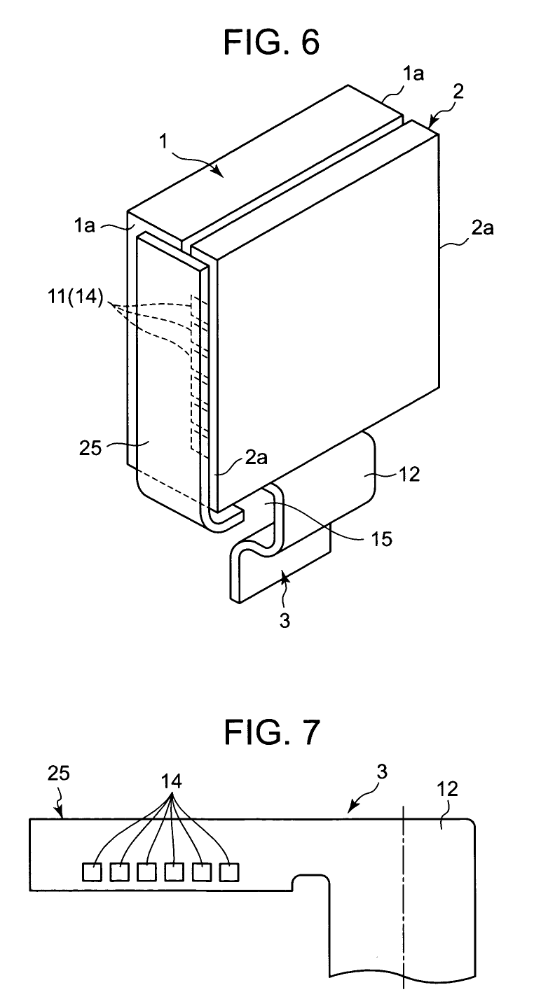

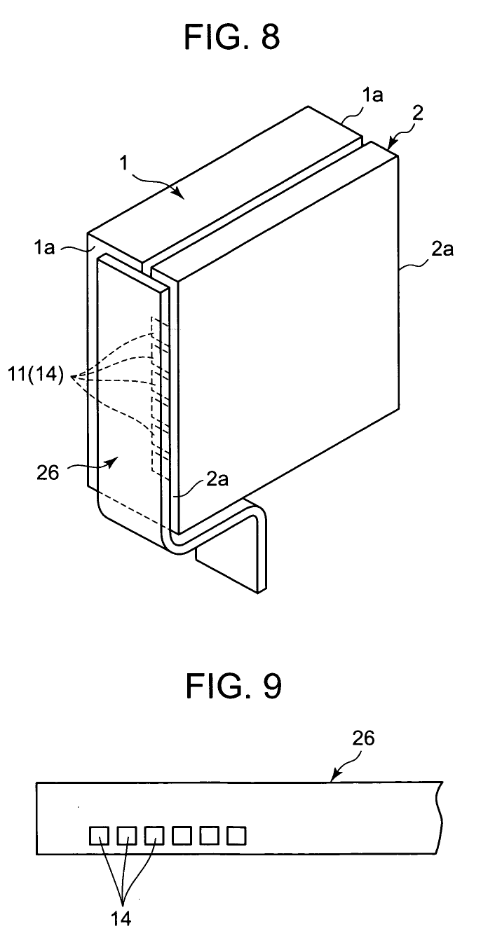

In the first and second embodiments described above, the element connecting pads 11 are provided on both side walls 2a, 2a of the image pick-up element unit 2, and meanwhile the film plate 3 is made to form a generally T-shape having the pair of extending portions 13, 13, on which the plate connecting pads 14 are provided to be stacked on the element connecting pads 11 when the pair of extending portions 13, 13 are bent from the central portion 12 of the film plate 3 to be firmly attached on the side walls 2a, 2a of the image pick-up element unit 2. But the connecting structure is not limited to the above mentioned embodiments and may be modified as shown by way of example in a first modification of FIGS. 6 and 7, and in a second modification of FIGS. 8 and 9.

In the first modification shown in FIGS. 6 and 7, the element connecting pads 11 are provided only on one side wall 2a of the image pick-up element unit 2, and the film plate 3 is made to form a generally L-shape having a single extending portion 25, on which the plate connecting pads 14 are provided to be stacked on the element connecting pads 11 when the extending portion 25 is bent from the central portion 12 of the film plate 3 to be firmly attached on the side wall 2a of the image pick-up element unit 2. With the connecting structure, the extending portion 25 of the film plate 3 is simply bent from the central portion 12, and therefore the similar effects to those of the first embodiment will be obtained. In the first modification, when a reinforcing plate (not shown) is attached to an external surface of the extending portion 25 of the film plate 3, the extending portion 25 of the film plate 3 may be firmly attached onto the side wall 2a of the image pick-up element unit 2 with the aid of the reinforcing plate as in a similar manner to the second embodiment.

In the second modification shown in FIGS. 8 and 9, the element connecting pads 11 are provided only on one side wall 2a of the image pick-up element unit 2, and a film plate 26 is made to form a generally I-shape. The width of the film plate 26 is made equivalent to or less than a width of an area including the side surfaces (1a, 2a) of the lens unit 1 and the image pick-up element unit 2. With the connecting structure, one end portion of the film plate 26 is firmly attached to one side wall 2a of the image pick-up element unit 2 and other end portion of the film plate 26 is bent at a position under the image pick-up element unit 2 as shown in FIG. 8. The connecting structure of the second modification is made simpler than the first modification. In the second modification, if a reinforcing plate (not shown) is attached to an external surface of the film plate 26, the film plate 26 may be firmly attached onto the side wall 2a of the image pick-up element unit 2 with the aid of the reinforcing plate.

In the first and second embodiments, the connecting structure which is used in the electronic camera has been described, but the connecting structure may be used in a video camera and other electronic apparatuses such as a cellular phone and a personal computer which is equipped with an image pick-up device such as a compact camera.

1. A connecting structure comprising:
an image pick-up element unit including an image pick-up element;
a wiring plate prepared to be attached to a side wall of the image pick-up element unit formed substantially in parallel with an optical axis of the image pick-up element;
at least an element connecting pad provided on the side wall of the image pick-up element unit and electrically connected to the image pick-up element; and
at least a plate connecting pad provided on the wiring plate, wherein the plate connecting pad is stacked on top of the element connecting pad provided on the side wall of the image pick-up element unit to be electrically connected with the same when the wiring plate is firmly attached onto the side wall of the image pick-up element unit.

2. The connecting structure according to claim 1, wherein the wiring plate is made of a flexible film plate.

3. The connecting structure according to claim 2, wherein the element connecting pads are provided on both side walls of the image pick-up element unit;
the film plate has a central portion and a pair of extending portions extending from the central portion; and
the plate connecting pads are provided on the extending portions and are stacked on top of the element connecting pads of the image pick-up element unit when the extending portions of the wiring plate are bent to be firmly attached onto the side walls of the image pick-up element unit.

4. The connecting structure according to claim 2, further comprising:
a reinforcing plate provided on an external surface of the wiring plate firmly attached on the side wall of the image pick-up element unit.

5. The connecting structure according to claim 3, further comprising:
a reinforcing plate provided on an external surface of the wiring plate firmly attached on the side wall of the image pick-up element unit.

6. A connecting structure comprising:
a lens unit containing a lens for picking up an image of an object;
an image pick-up element unit containing an image pick-up element, and provided with element connecting pads on it side wall, the image pick-up element unit being fixed onto the lens unit such that an optical axis of the image pick-up element coincides with an optical axis of the lens;
a wiring plate provided with plate connecting pads adapted to be electrically connected with the element connecting pads of the image pick-up element unit,
wherein when the wiring plate is firmly attached onto the side wall of the image pick-up element unit, the plate connecting pads of the wiring plate are firmly stacked on top of the element connecting pads of the image pick-up element unit.
